(19) United States
(12) Patent Application Publication
(10) Pub. No.: US 2008/0046295 A1
(43) Pub. Date: Feb. 21, 2008

(54) MEDICAL MANAGEMENT SYSTEM

(76) Inventor: JEFFREY STEVEN ALBRECHT, Austin, TX (US)

Correspondence Address: MORGAN & FINNEGAN, L.L.P., 3 WORLD FINANCIAL CENTER, NEW YORK, NY, 10281-2101, US

(21) Appl. No.: 11/857,684

(22) Filed: Sep. 19, 2007

Related U.S. Application Data
(63) Continuation of application No. 09/579,872, filed on May 26, 2000, now abandoned.

(51) Int. Cl. G06Q 50/00; G06F 17/30; G06F 17/40

(52) U.S. Cl. 705/3; 707/104.1

(57) ABSTRACT

A medical management system. The burdensome task of medication logging is greatly reduced for a patient when compared to conventional methods to perform these tasks. Moreover, the invention allows for pharmaceutical supplier/providers and healthcare providers the ability better to manage, track, and trend the medication and products that must be provided to patients. This integrated ability allows for better management of the inventory of highly perishable and life-saving medications for chronically ill patients. The invention also allows for highly accurate communication between patients and other parties including his/her medical doctor, a pharmaceutical supplier/provider who provides medications and products for the patient, as well as the insurance provider providing medical insurance coverage for the patient. The system integrates embedded functionality that ensures that in the accidental event that a patient is prescribed tainted medication, the patient is warned of the taint in due time before self-administering the medication to avoid potentially contracting a disease or other ailment from the tainted medication. Patient medication is tracked and trending over the lifetime of the medication and the treatment period for the patient. Exceptions that outlay the trending of the patient's medication are identified and properly communicated, sometimes automatically, to a healthcare provider or medical doctor who treats the patient. The system is adaptable for use generally or to treat specific diseases, such as chronic diseases as hemophilia, diabetes, asthma, HIV, and other diseases requiring long term treatment and ongoing administration of medications and products.

### CROSS REFERENCE TO RELATED APPLICATION

This is a continuation application of Ser. No. 09/579,872 “Medical Management System” filed on May 26, 2000 and international application number PCT/US01/05099 filed on Feb. 16, 2001. The disclosures of the aforementioned applications are incorporated herein by reference.

### BACKGROUND

1. Technical Field

The present invention relates generally to individualized patient medication administering and prescribing; and, more particularly, it relates to a medical management system that is operable to perform patient medication administration, prescription, and management to enable timely and accurate communication between a patient, a medication supplier, and a health care provider.

2. Related Art

Conventional systems that seek to integrate logging of reports of medication administration suffer from many deficiencies. One such undesirable and burdensome task that is presented to patients having chronic illnesses is the repetitive submission of medication logs to healthcare providers, pharmaceutical providers, and sometimes medical insurance companies. Several conventional methods have been attempted to try to eliminate some of the hassle of submitting medication logs to these various parties, yet there nevertheless remains a great deal of burden that is left placed upon the individual patient. Specifically for those patients suffering from chronic diseases requiring significant and repeated administration of medication, maintaining accurate record-keeping of the administration of their medication as well as recording any additional information relating to their disease creates an enormous amount of burden including paperwork and intrusion into their individual lives.

For example, in treating some chronic diseases, conventional methods have attempted to ease the logging of medication administration via various methods. One such method is the use of telephonic interviewing of the patient at predetermined intervals to ensure that accurate record-keeping of the administration of the mediation as well as any additional information pertaining to the disease are properly recorded. This presents a very undesirable approach from the patient's perspective. First of all, there is almost continually an intrusion into the individual social sphere of the patient. The patient is not given any real degree of autonomy of ensuring that the record-keeping is performed on a consistent basis. In addition, another conventional approach to minimize the burden of paperwork has been to provide patients with “scantron” types of documents wherein the patient will “fill in the bubbles” of their medication administration and any other medical information. This method suffers from many deficiencies including an inability to gain accurate data from across a wide patient cross section in that the accuracy of the data is solely a function of the diligence of the individual patients who participate in such a mediation logging method. While this conventional method may present a solution for some patients, it still presents a radical deficiency, in that, across a large patient base, many of the patients will not exert the time and effort required in such a system to ensure that accurate record-keeping is being performed.

As far from a global perspective in treating an illness among an entire population, the conventional methods that seek to provide for any degree of integration of record-keeping suffer from a major drawback, in that, there is no uniformity in the format in which record-keeping is performed across various diseases. Moreover, even across a single disease category, there still is not uniformity in the record-keeping of medication administration and patient treatment. There are many different types and forms in which patient data is collected. That is to say, even among a common disease, different healthcare providers, pharmaceutical providers, and even insurance companies retrieve sometimes largely different information. This leaves a very large deficiency in the treating of the disease from a global perspective, in trying to provide total disease management for a population as described above.

For those methods that offer certain degrees of autonomy in completing medication and treatment logging for patients, there is still sufficient deficiency, in that, many patients do not complete the medication and treatment logs until immediately before they are requested by any of the service providers described above, namely, healthcare providers, pharmaceutical providers, and insurance companies. For example, a patient, burdened by the laborious manner in which data is gathered, many of these patients simply procrastinate in completing their medication and treatment logs until immediately before they are due. The accuracy of this information is necessarily compromised, in that, there is a virtual inability for all patients to remember exactly how much medication has been administered, exactly when it was administered, as well as all of the specifics of the particular condition that has transpired to necessitate the treatment itself. There still does not exist a substantially easy and automated manner in which a patient can provide to these many service providers information pertaining to his/her self-administration and self-treatment concerning his/her disease. These data compilation constraints under which patients with chronic diseases and other diseases requiring frequent medical treatment precipitate inaccurate data for their disease treatment. Healthcare providers cannot accurately trend the medication usage and administration of their patients having this inaccurate information.

Also, patients and healthcare providers are not the only members of the healthcare industry who suffer from poor record-keeping and medication tracking. Pharmaceutical providers also suffer from this inaccurate information in managing their medication and product inventories. This inability becomes especially pronounced for life-saving medications and products. Pharmaceutical providers need to be able to ensure that patients have access to all of the life-saving and life-preserving medications and product at all times. Under conventional methods, this inherently demands keeping an excess of medication and product for such treatments in relatively large bulk. Particularly when dealing with medications and products that have relatively short shelf lives, or are deemed perishable, this can present significant cost increase in terms of the man hours that are required to maintain and monitor the inventory of such medications and products. Much perishable medication and product is wasted when using these conventional methods. One such conventional method that seeks to address this problem is closely related to the manner in which patient medication and treatment logs are retrieved via telephonic interview. To provide better management of their inventory, some pharmaceutical providers will perform telephone polling to their high risk and needy patients to ensure that they have sufficient medication and product at hand in the case of an emergency.

In addition, there is a medication and product management difficulty for both the pharmaceutical providers and the patients, in that, for those highly perishable medications and products, there is always the possibility that medications and products are close to expiration of their shelf lives. Moreover, tainted medications and products present an even greater difficulty to manage, in that, a patient can contract sometimes life-threatening diseases from administration of such tainted medications and products. There exists today no manner in which patients are provides alerts to such tainted or corrupted medications and products in an adequately timely fashion. Conventional systems simply fail to provide adequate communication between the manner providers and consumers within the healthcare industry.

Further limitations and disadvantages of conventional and traditional systems will become apparent to one of skill in the art through comparison of such systems with the present invention as set forth in the remainder of the present application with reference to the drawings.

### SUMMARY OF THE INVENTION

Various aspects of the present invention can be found in a medical management system that includes a personal communication device, an integrated communication network, and a HemaScan database. The personal communication device is used by a patient to perform a number of functions including medication logging and interactive communication. The integrated network that is communicatively coupled to the personal communication device and provides inter-communication between the patient and a number of other parties including a healthcare provider and a pharmaceutical supplier/provider. The HemaScan database contains, among other things patient education material and a product catalog, and it is operable to perform automated medication reorder processing for the patient. The medication logging performed by the system is partially automated and partially interactive, allowing the patient to verify the partially automated medication logging.

In certain embodiments of the invention, the medical management system also contains an additional personal communication device that is used by another patient to perform medication logging and interactive communication. The patient and the other patient communicate using their respective personal communication devices the HemaScan database is tailored for any number of diseases, if desired, and it is specifically tailored to a single diseases, such as hemophilia in other embodiments of the invention. The personal communication device includes a wireless communication device and the integrated network includes a wireless communication network such that the personal communication device is in continuous communication with the wireless communication network. The HemaScan database is operable with the integrated communication network to perform medication tracking and medication trending of medication that is administered by the patient as well as to perform medication inventory tracking and medication inventory trending. Also, the HemaScan database is operable to perform medication inventory tracking of a tainted medication and to communicate to the patient information that identifies the tainted medication.

Other aspects of the present invention can be found in a medical management system that includes, among other things, a wireless communication network, a dedicated secure network, a HemaScan database, and a wireless communication device. The HemaScan database is communicatively coupled to the wireless communication network and the dedicated secure network, and the wireless communication device is communicatively coupled to the wireless communication network. The dedicated secure network communicatively couples the HemaScan database to a pharmaceutical supplier/provider, and the wireless communication network further communicatively couples the HemaScan database to the wireless communication device that is used by a patient to perform a number of functions including medication logging and interactive communication. The HemaScan database is operable to perform automated medication reorder processing for the patient from the pharmaceutical supplier/provider. The medication logging is partially automated and partially interactive, allowing the patient to verify the partially automated medication logging.

In certain embodiments of the invention, the medical management system includes another wireless communication device that is communicatively coupled to the wireless communication network that is used by another patient to perform a number of functions including medication logging and interactive communication. The internet is communicatively coupled to the HemaScan database, and medical doctor associated with a healthcare provider accesses the HemaScan database through the internet via a secure communication link. The medical doctor is able to communicate a message to the patient. If desired, the healthcare provider performs medication tracking and medication trending specific to the patient and transmits that information to an insurance provider. The HemaScan database is operable to transmit any number of messages to the patient including messages indicating a tainted medication. This information is passed to the patient in real time in certain embodiments of the invention. The HemaScan database is specifically tailored to any number of diseases including hemophilia.

Other aspects of the present invention can be found in a medical management system having a personal communication device, a modem pool dial-up, a dedicated secure network, and a HemaScan database. The personal communication device is used by a patient to perform a number of functions including medication logging and interactive communication. The modem pool dial-up that allows remote secured login from the personal communication device, and the HemaScan database is operable to perform automated medication reorder processing for the patient from a pharmaceutical supplier/provider.

In certain embodiments of the invention, the HemaScan database is operable to perform medication logging that is partially automated and partially interactive allowing the patient to verify the partially automated medication logging. The HemaScan database is operable to perform medication inventory tracking of a tainted medication that has been provided by the pharmaceutical supplier/provider, and to identify the tainted medication that has been provided from the pharmaceutical supplier/provider to the patient. The HemaScan database is tailored to deal with any number of diseases including hemophilia.

Other aspects, advantages and novel features of the present invention will become apparent from the following detailed description of the invention when considered in conjunction with the accompanying drawings.

### BRIEF DESCRIPTION OF THE DRAWINGS

A better understanding of the present invention can be obtained when the following detailed description of various exemplary embodiments are considered in conjunction with the following drawings.

FIG. 1 is a functional diagram illustrating an embodiment of the inter-functionality and communication provided between certain of the providers and consumers of the healthcare industry using a HemaScan database that is part of a medical management system in accordance with the present invention.

FIG. 2 is a system diagram illustrating an embodiment of an integrated communication system that interconnects certain of the providers and consumers of the healthcare industry using a HemaScan database that is part of a medical management system in accordance with the present invention.

FIG. 3 is a system diagram illustrating another embodiment of an integrated communication system that interconnects certain of the providers and consumers of the healthcare industry using a HemaScan database that is part of a medical management system in accordance with the present invention.

FIG. 4 is a system diagram illustrating another embodiment of an integrated communication system that interconnects multiple patients and certain of the providers within the healthcare industry using a HemaScan database that is part of a medical management system in accordance with the present invention.

FIG. 5 is a system diagram illustrating another embodiment of an integrated communication system that interconnects multiple patients via wireless communication and certain of the providers within the healthcare industry using a HemaScan database that is part of a medical management system in accordance with the present invention.

FIG. 6 is a system diagram illustrating an embodiment of the functionality and inter-communication provided for and between certain of the providers, consumers, and researchers of the healthcare industry as provided by employing a HemaScan database that is part of a medical management system built in accordance with the present invention.

### DETAILED DESCRIPTION OF THE INVENTION

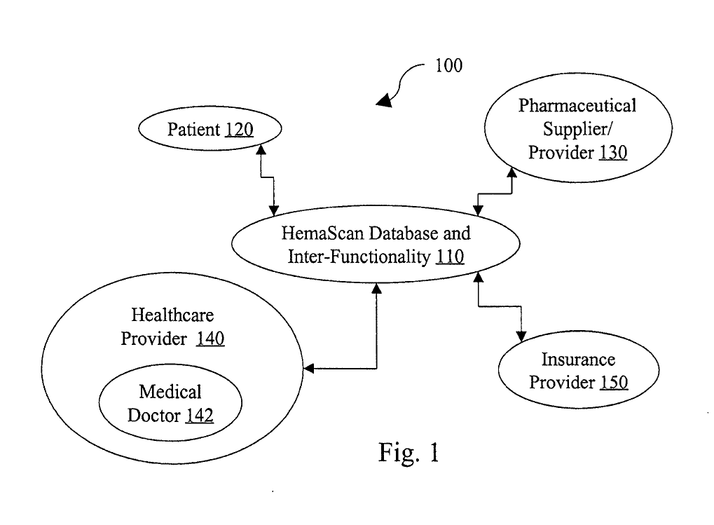

FIG. 1 is a functional diagram illustrating an embodiment of an inter-functionality and communication 100 provided between certain of the providers and consumers of the healthcare industry using a HemaScan database that is part of a medical management system in accordance with the present invention. A patient 120 communicates with a pharmaceutical supplier/provider 130, a healthcare provider 140, and an insurance provider 150 through a HemaScan database providing inter-functionality 110. The HemaScan database and inter-functionality 110 provides the manner in which each of the various parties communication with one another. In addition, the HemaScan database and inter-functionality 110 provides specific functionality, many embodiments of which are described in greater detail below, that assists each of the various parties to communicate with one another in a manner that is significantly less burdensome than the manner of communication provided using conventional methods of communication and interaction.

The healthcare provider 140 includes, among other providers to healthcare, a medical doctor 142 who provides professional medical services to the patient 120. The conventional methods that seek to provide for the communication and interaction between the medical doctor 142 and the patient 120 almost always incorporate an additional party to assist in the communication between them. A great deal of man hours are required by the medical doctor 142, or employees of the medical doctor 142, such as secretaries and nurses to maintain accurate record-keeping for the patient 120. Such record-keeping includes the logging of the specific medications and products that are being prescribed to the patient 142. In addition, information must be logged indicating the frequency of medications and products that are prescribed to the patient 120 to assist in trending the amount and type of medications and products that the patient 120 is self-administering and self-prescribing. This is particularly important in treating diseases wherein the patient is asked to provide a great deal of autonomy.

Moreover, such diseases that are treated by a patient administering a medication or product in response to a reaction, an accident, or some other symptom associated with the disease that present even greater difficulty in maintaining accurate record-keeping of the treatment and administration of medications and products to treat the disease benefit significantly from the inter-functionality and communication 100 provided within the FIG. 1, in that, each and every time the patient 120 administers any medication or product for any of the aforementioned reasons, the HemaScan database will assist to ensure that the medical doctor 142 receives accurate and detailed medication and product logging at predetermined intervals of time this way, the medical doctor 142 can properly trend the medication administration of the patient 120 and provide better prognosis and treatment of the disease. Moreover, many insurance providers require substantially detailing record-keeping for the patient 120 to permit full coverage for extremely expensive medication prescription. For many chronic diseases, especially those requiring highly perishable and life-saving medications and products, the per unit cost of those medications and products can be exorbitant. For better cost management from the perspective of the insurance provider 150, in terms of determining whether or not full coverage of certain treatments as well as the prescription of certain medications and products are deemed absolutely necessary, the trending of the medication administration and self-treatment and self-administration performed by the patient 120 is provided in accurate detail.

In addition, from a macro or global perspective, when the insurance provider 150 manages its entire medical healthcare coverage across its patient base, the insurance provider 150 will be better able to predict the costs associated with providing adequate care for certain patients having certain diseases. This way, the insurance provider 150 will better be able to predict the needs of the patient 120 (as well as any other patients to whom the insurance provider 150 provides insurance coverage) and be able to manage their entire coverage portfolio better. One such manner in which the insurance provider 150 is better able to provide coverage is to enter into certain longer term relationships with medication and product providers, such as the pharmaceutical supplier/provider 130 under certain requirement type of contracts wherein the pharmaceutical supplier/provider 130 is assured that certain levels of medications and products will be required. Herein, the pharmaceutical supplier/provider 130 will also better be able to manage its inventory of all of its medications and products. No doubt the pharmaceutical supplier/provider 130 would be willing to pass on some of the savings to the insurance provider 150 and the patient 120. This represents one such example of the synergy that is generated using the HemaScan database and inter-functionality 110 that provides greater communication that ensures more accurate record-keeping between the various parties of the inter-functionality and communication 100 illustrated in the FIG. 1. Certainly other benefits are conferred by easier and less burdensome communication between the various parties represented herein.

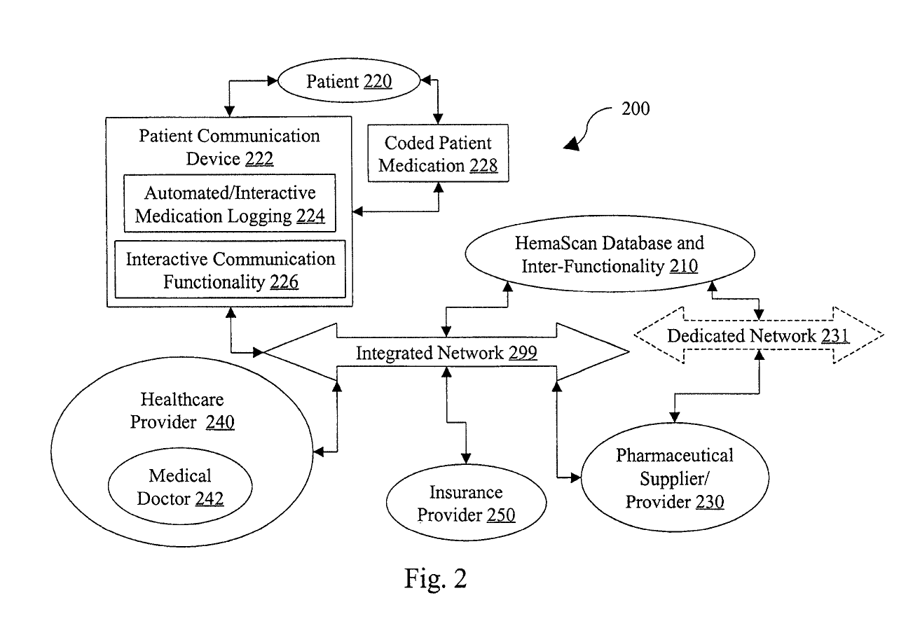

FIG. 2 is a system diagram illustrating an embodiment of an integrated communication system 200 that interconnects certain of the providers and consumers of the healthcare industry using a HemaScan database that provides inter-functionality in accordance with the present invention. The HemaScan database is part of a medical management system. A patient 220, a healthcare provider 240 including a medical doctor 242, an insurance provider 250, and a pharmaceutical supplier/provider 230 all inter-communicate via an integrated network 299 borrowing upon the inter-functionality provided by a HemaScan database 210. If desired in certain embodiments of the invention, the HemaScan database and its inter-functionality 210 have dedicated communication with the pharmaceutical supplier/provider 230 via a dedicated network 231. Otherwise, the HemaScan database and its inter-functionality 210 communicates with the pharmaceutical supplier/provider 230 via the integrated network 299.

The patient 220 employs a patient communication device 222 to interface with the integrated network 299 to communicate with each of the other parties within the integrated communication system 200 of the FIG. 2. The patient communication device 222 performs, among other functions, automated/interactive medication logging 224 and interactive communication functionality 226. The patient 220 is prescribed medication that is shown as a coded patient medication 228. The coded patient medication 228 borrows upon the automated/interactive medication logging 224 functionality of the patient communication device 222 to record certain information pertaining to the coded patient medication 228 in an accurate and practically burden-free manner.

For example, in certain embodiments of the invention, a vial of patient medication is coded such that its information is easily read and interpreted using the automated/interactive medication logging 224 functionality of the patient communication device 222 whenever the medication is administered by the patient 220. That coding information assists the patient 220 in performing accurate record-keeping of the medication that is administered. Certain options are also presented to the patient 220 to enter in additional information concerning the administration of the medication. For example, if the patient 220 desired to enter in additional information besides that information that is automatically entered using the automated functionality of the automated/interactive medication logging 224 functionality, the patient 220 uses the interactive functionality of the automated/interactive medication logging 224 functionality to do so. Examples of such information include symptoms associated with why the patient 220 has chosen to administer medication, and other information associated with the self-treatment that is performed by the patient 220.

Certain information, such as the amount of medication, the precise type of medication, the time that the medication is administered, the exact vial of medication that is used, are all information that is easily automatically logged, in that, certain of the information is already coded on the vial of the coded patient medication 228. Certain other information is automatically recorded, such as the date and time in which the coded patient medication 228 is administered. Such information is automated within the patient communication device 222 itself using an internal clock or other embedded intelligence. In certain embodiments of the invention, the patient 220 is provided the authority to override any of the automatic recording that is performed by the automated/interactive medication logging 224 functionality of the patient communication device 222. Nevertheless, the patient 220 is provided a manner in which medication logging that is substantially less burdensome than medication logging that is performed using conventional methods.

The interactive communication functionality 226 of the patient communication device 222 allows the patient 220 to access information from the HemaScan database 210 independently. In addition, the interactive communication functionality 226 provides the manner in which medication and treatment logs are easily and accurately transmitted to the healthcare provider 240, the insurance provider 250, and the pharmaceutical supplier/provider 230. All parties involved in the cooperative treatment of the patient 220 are provided with accurate information concerning medication logs.

The medical doctor 242 is easily provided with accurate and detailed medication logs for the patient 220. In addition, for other patients that employ the services of the medical doctor 242, the medical doctor 242 already has very accurate and detailed information for reporting to government and medical institutions such as the Center for Disease Control (CDC), the National Institutes of Health (NIH), the American Health Information Management Association (AHIMA), and the World Health Organization (WHO), among others. Significant man hours are saved by the medical doctor 242 and his/her employees in the preparation and tabulation of such reports and information that is desired to be provided to entities such as these. As will be discussed in further detail below, medical researchers and market researchers will also benefit greatly from having this type of information accessible in a uniform, centralized, and organized manner.

The patient communication device 222 allows the patient 220 to receive warnings about tainted medications and products that may be in the hands of the patient 220. The pharmaceutical supplier/provider 230 is enabled to provide virtually immediate warning messages to patients who might have medications and products that may be tainted. For example, in treating one such disease, hemophilia, factor is provided to the patient 220. Despite the existent, modern, and advanced screening methods employed to reduce the risk of acquiring tainted factor (e.g., tainted containing HIV or hepatitis), there is nevertheless sometimes acquired tainted factor. The ability of the pharmaceutical supplier/provider 230 to be able to communicate to the patient 220 that he/she possesses tainted factor in a virtually immediate manner will prevent certain patients from infusing the tainted factor. In addition, given the fact that the factor, in this embodiment shown as the coded patient medication 228, the specific vial of factor that is tainted will be easily trackable and each and every patient need not be given a warning notice, but only that specific patient to whom the tainted vial of factor was accidentally prescribed.

One desirable by-product of having this highly accurate method of communication between the pharmaceutical supplier/provider 230 and the patient 220 is that there is the ability to provide very specific warning and alarm functionality specifically targeted to the patient 220. Widespread panics can be avoided, and even the trauma through which small numbers of patients must endure can be all but eliminated by ensuring that only those patients who need to receive warnings actually do receive warnings. Particularly within diseases that suffer from extreme consequences of tainted product, such as the treatment of hemophilia and other blood related diseases, there can be a great degree of fear associated with receiving warnings that a patient's source of medication or product is potentially tainted. To be able to reduce, if not eliminate, improper warnings to patients to whom such warnings need not be communicated (i.e., those patients do not possess any of the medications and products that are tainted), the patient satisfaction and reduction in fear will be greatly reduced.

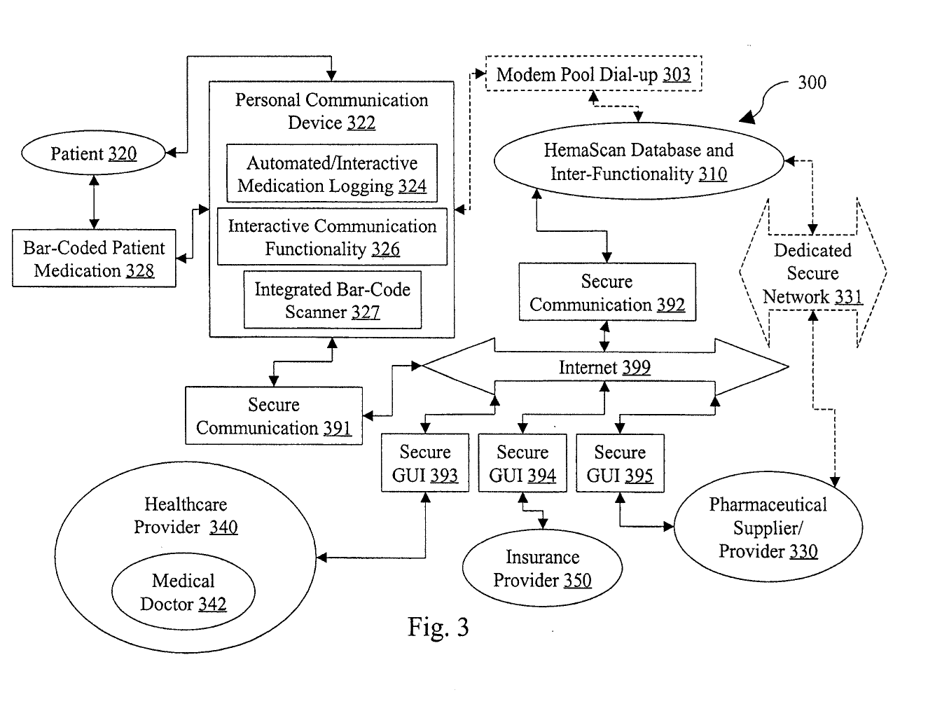

FIG. 3 is a system diagram illustrating another embodiment of an integrated communication system 300 that interconnects certain of the providers and consumers of the healthcare industry using a HemaScan database providing inter-functionality 310 in accordance with the present invention. The HemaScan database is part of a medical management system. A patient 320, a healthcare provider 340 including a medical doctor 342, an insurance provider 350, and a pharmaceutical supplier/provider 330 all inter-communicate via an internet 399 borrowing upon the inter-functionality provided by a HemaScan database 310. All of the inter-communication is secure between the various parties coupled to the integrated communication system 300 in the embodiment shown in the FIG. 3. For example, the healthcare provider 340 and the medical doctor 342 communicate to the internet 399 via a secure general user interface (GUI) 393. Similarly, the insurance provider 350 communicates to the internet 399 via a secure GUI 394; the pharmaceutical supplier/provider communicates to the internet 399 via a secure GUI 395.

All access to the HemaScan database and its associated inter-functionality 310 via the internet is provided via secure communication 392. The patient 320 employs a personal communication device 322 to access the internet 399 via secure communication 391. Various methods are employed to perform secure communication for the secure communication 391, the secure communication 392, and the Guls 393, 394, and 395. For example, a username and password are used in certain embodiments of the invention. In other embodiments of the invention, other methods of authentication are performed as known within the art of authentication and secure communication between various entities using the internet 399.

If desired in certain embodiments of the invention, the personal communication device 322 employed by the patient 320 performed a direct dial-up procedure via a modem pool dial-up 303 to access the HemaScan database 310. Moreover, the HemaScan database 310 communicates directly with the pharmaceutical supplier/provider 330 via a dedicated secure network 331. This way, the patient 320 can access the HemaScan database 310 to access all sorts of medical information without needing to go through the internet 399. Similarly, the HemaScan database 310 has the ability to communicate with the pharmaceutical supplier/provider 330 without having to go through the internet 399.

The personal communication device 322 of the patient 320 performs, among other functions, automated/interactive medication logging 324 and interactive communication functionality 326, and it also contains an integrated bar-code scanner 327. The patient 320 is provided with bar-coded patient medication 328 that is easily read using the integrated bar-code scanner 327 of the personal communication device 322. The personal communication device 322 is a variety of many types of personal communication devices such as a handheld communication device such as a PalmPilot. Certain handheld personal communication devices allow simplified integration of the integrated bar-code scanner 327. One embodiment of the invention specifically employs a PalmPilot having the integrated bar-code scanner 327 that is provided by a 3^{rd} party vendor. Similar to the embodiment of the invention described above in the FIG. 2, the patient is provided a very burden-free manner of entering medication logging borrowing on the very fast and simplified reading of information on the bar-coded patient medication 328 using the integrated bar-code scanner 327 of the personal communication device 322.

As also described above in other embodiments of the invention, the patient 320 has the ability to access the HemaScan database 310 through the interactive communication functionality 326. The interactive communication functionality 326 is a menu-driven browser that allows the patient 320 access various disease, medication, and treatment information contained within the HemaScan database 310. For example, the HemaScan database 310 is adaptable to be tailored to deal with patients having a specific disease in certain embodiments of the invention. If desired, the HemaScan database 310 is tailored toward hemophilia patients. If also desired, the HemaScan database 310 is tailored toward cancer patients, asthmatic patients, diabetic patients, or tailored toward any group of patients suffering from a other specific disease. Alternatively, the HemaScan database 310 is tailored toward medical patients in general, maintaining searchable sub-categories through which patients accessing the HemaScan database 310 can find precisely that type of information that they are seeking.

The personal communication device 322 is designed to allow the patient 320 to access all of the information contained within the HemaScan database. Not only does the personal communication device 322 allow simplified logging of medication administration and self treatment performed by the patient 320, but it also allows for the patient 320 to retrieve pertinent information from the HemaScan database 310. Also, as described above in the various embodiments of the invention, borrowing upon the highly accurate bar-code tracking of the bar-coded patient medication 328, alarm functionality in terms of warnings of tainted patient medication is directed specifically to the patient to whom the tainted medication has been prescribed. The medication tracking functionality of the invention allows for minimizes “false alarms” to be given to patients to whom tainted medication has not been accidentally prescribed, thereby minimizing undue fear and trauma, as described above.

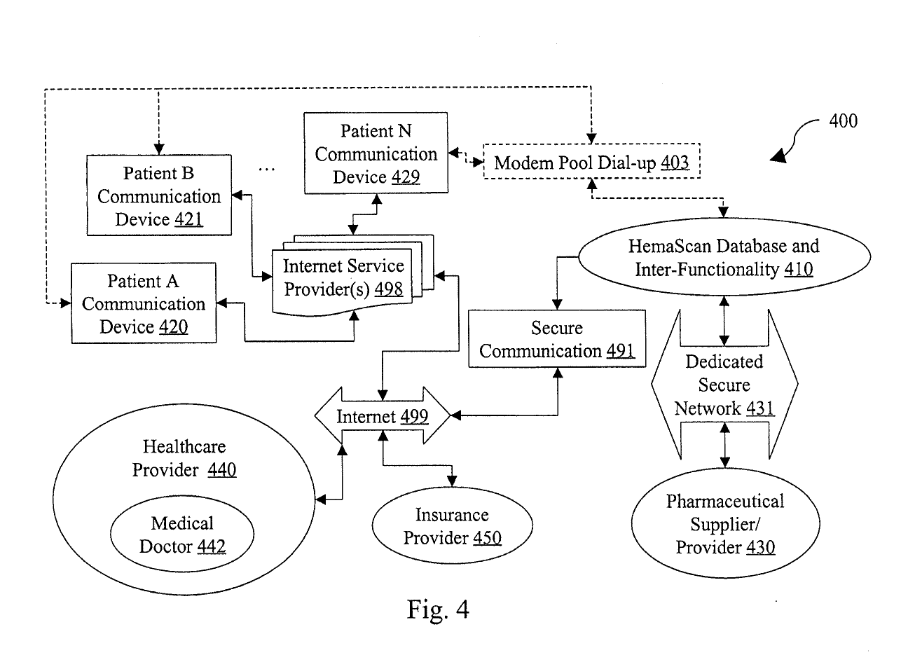

FIG. 4 is a system diagram illustrating another embodiment of an integrated communication system 400 that that interconnects multiple patients and certain of the providers within the healthcare industry using a HemaScan database in accordance with the present invention. The HemaScan database is part of a medical management system. The integrated communication system 400 illustrated yet another manner in which various entities within the medical industry are provided accurate communication and sharing of information.

Multiple patient communication devices, illustrated by a patient A communication device 420, a patient Buyer communication device 421, and a patient N communication device 429 all allow various patients to whom the patient communication devices 420, 421, and 429 have been assigned to communicate with a healthcare provider 440 including a medical doctor 442, and an insurance provider 450 via an internet 499 borrowing upon the inter-functionality provided by a HemaScan database 410. A dedicated secure network 431 ensures communication between the HemaScan database 410 and a pharmaceutical supplier/provider 430. Each of the patient communication devices 420, 421, and 429 employ at least one of any number of internet service provider(s) 498 to access the internet 499 through which they access the HemaScan database 410. Alternatively, each of the patient communication devices 420, 421, and 429 access the HemaScan database 410 through a modem pool dial-up 403 that itself provides integration between the HemaScan database 410 and the patient communication devices 420, 421, and 429.

All of the desirable functionality described above the various embodiments of the invention is also provided within the integrated communication system 400. For example, if desired in the specific embodiment, medication coding is provided, alarm functionality notifying patients of tainted medication is provided, and accurate medication logging is provided, among other functionality described in the various embodiments of the invention.

The integrated communication system 400 provides yet another manner in which the various entities are all inter-connected. The integrated communication system 400 also illustrated an embodiment of the invention wherein multiple patients all access the HemaScan database 410 simultaneously through the various internet service provider(s) 498 in one embodiment of the invention and through the modem pool dial-up 403 in other embodiments of the invention. In addition, the HemaScan database 410 does not communicate with the pharmaceutical supplier/provider 430 via any communication media except the through the dedicated secure network 431.

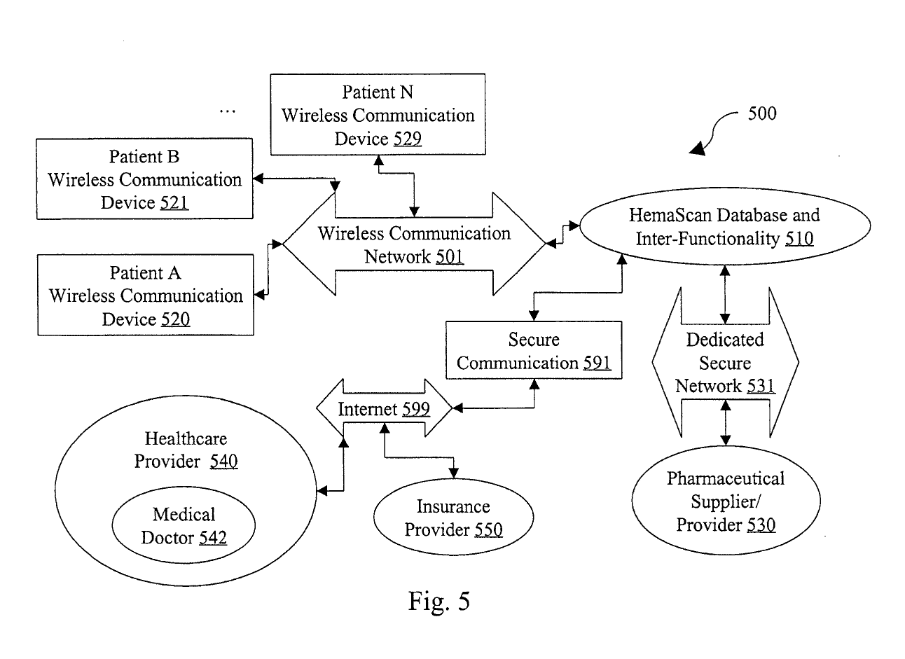

FIG. 5 is a system diagram illustrating another embodiment of an integrated communication system 500 that that interconnects multiple patients via wireless communication and certain of the providers within the healthcare industry using a HemaScan database in accordance with the present invention. The HemaScan database is part of a medical management system. The integrated communication system 500 illustrated yet another manner in which various entities within the medical industry are provided accurate communication and sharing of information.

Multiple patient wireless communication devices, illustrated by a patient A wireless communication device 520, a patient B wireless communication device 521, and a patient N wireless communication device 529 all allow various patients to whom the patient wireless communication devices 520, 521, and 529 have been assigned to communicate with HemaScan database 510 via a wireless communication network 501. The HemaScan database 510 communicates with a healthcare provider 540 including a medical doctor 542 and an insurance provider 550 via secure communication 591 through an internet 599. In addition, the HemaScan database 510 communicates with a pharmaceutical supplier/provider 530 via a dedicated secure network 531. Each of the patient wireless communication devices 520, 521, and 529 are able to communicate with the healthcare provider 540 and the insurance provider 550 via the HemaScan database 510 borrowing upon its inter-connectivity of the HemaScan database 510 to them through the secure communication 591 that couples the HemaScan database to the internet 591.

All of the desirable functionality described above the various embodiments of the invention is also provided within the integrated communication system 500. For example, if desired in the specific embodiment, medication coding is provided, alarm functionality notifying patients of tainted medication is provided, and accurate medication logging is provided, among other functionality described in the various embodiments of the invention.

In certain embodiments of the invention, each of the patient wireless communication devices 520, 521, and 529 is a wireless communication device that a patient carries with him at all times, in much the same way that the patient would carry a cellular telephone or a pager. Each of the patient wireless communication devices 520, 521, and 529 are in communication with the HemaScan database 510 in real time. Messages, alarms, and any other information is readily passed to the patients who use the integrated communication system 500 in real time. Examples presented above, such as those wherein patients need to be alerted to tainted medication (i.e., tainted factor that has been accidentally prescribed to hemophilia patients), are provided such warning and alarm information in real time. In other embodiments the invention, a patient needs to connect his/her patient communication device or personal communication device to the various HemaScan databases illustrated in the various embodiments of the invention through either an integrated network or the internet. Only after the various communication devices employed in the previous embodiments of the invention are connected to the HemaScan databases can the various communication devices perform communication including transmission of such alarms, warnings, and notification functions such as those related to notification of tainted medication.

However, in the embodiment of the invention illustrated in the FIG. 5 of the integrated communication system 500, the patient wireless communication devices 520, 521, and 529 are operable to receive notification of such alarms or warnings in real time, borrowing upon the continual connectivity provided by the wireless communication network 501. Of course, when the patients leave an area to which wireless communication service is provided by the wireless communication network 501, the real time functionality of providing instant alarm, warning, and notification is compromised. As the expanse that is served by the wireless communication network 501 continues to expand to serve the patient wireless communication devices 520, 521, and 529, then the mobility of patients that use the integrated communication system 500 will similarly continue to increase while still maintaining that highly desirable ability to ensure that warnings and communication are provided to the patient 520 while providing the patient 520 with virtual autonomy in terms of mobility.

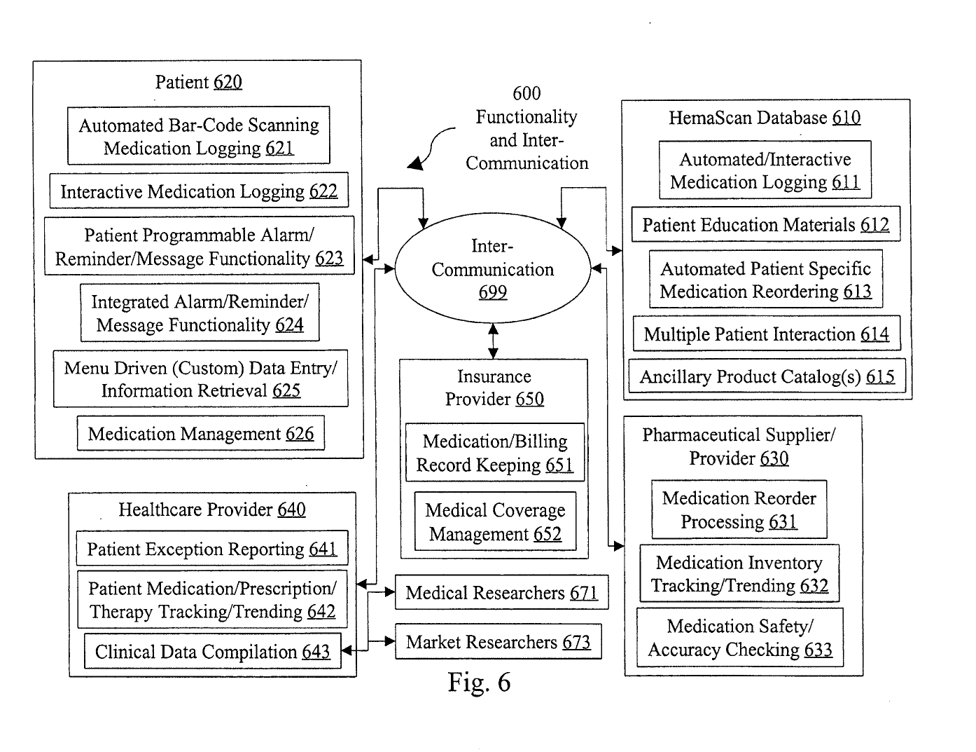

FIG. 6 is a system diagram illustrating an embodiment of an functionality and inter-communication 600 provided for and between certain of the providers, consumers, and researchers of the healthcare industry as provided by employing a HemaScan database that is part of a medical management system built in accordance with the present invention.

Specifically, the functionality that is provided to a patient 620, the functionality that is provided to a healthcare provider 640, the functionality provided to an insurance provider 650, the functionality offered by a HemaScan database 610, and the functionality afforded to a pharmaceutical supplier/provider 630 are all connected via an inter-communication 699. There are certain third party beneficiaries that are associated with the medical industry who benefit from the effective and highly accurate inter-communication 699 provided between the many entities illustrated in the FIG. 6. For example, medical researchers 671 and market researchers 673, having highly accurate information concerning, among other things, medication logging for multiple patients and highly accurate medication trending for those same patients, as well as highly accurate trending of the self-administration treatment performed by those patients concerning the treatment of their respective diseases, these two distinct groups, the medical researchers 671 and the market researchers 673, are better able to perform studies from a macro or global perspective concerning the total treatment of a given disease for which the functionality and inter-communication 600 having the HemaScan database 610 has been tailored. In addition, better analysis the economic considerations concerning disease treatment are intrinsically more accurate borrowing upon this highly improved gathering method of information as well as the easily facilitated communication between the parties.

The patient 620 is afforded functionality for, among other things, an automated bar-code scanning medication logging 621, an interactive medication logging 622, a patient programmable alarm/reminder/message functionality 623, an integrated alarm/reminder/message functionality 624, a menu driven (custom) data entry/information retrieval functionality 625, and medication management 626. The healthcare provider 640 is afforded functionality for, among other things, patient exception reporting 641, patient medication/prescription/therapy tracking/trending 642, and clinical data compilation 643. The patient exception reporting 641 is provided to the healthcare provider 640, and in some embodiments directly to the medical doctor who provides medical services to the patient 620, ensures that if when something is out of the norm with respect to the patient 620, the healthcare provider 640 is notified as soon as possible. This way, the healthcare provider 640 can properly adapt its treatment of the patient 620. Examples of exceptions include, among other things, instances when a patients self-administration of medication is significantly out of bounds of the trending of the patient's medication consumption as monitored using the patient medication/prescription/therapy tracking/trending 642, instances when the patient 620 has accidentally consumed tainted medication, and other exceptions known in the medical arts concerning the treatment of diseases.

The insurance provider 650 is afforded functionality for, among other things, medication/billing record keeping 651 and medical coverage management 652. The pharmaceutical supplier/provider is afforded functionality for, among other things, medication reorder processing 631, medication inventory tracking/trending 632, and medication safety/accuracy checking 633.

The HemaScan database 610 offers the functionality for, among other things, automated/interactive medication logging 611, the provision and organization of patient education materials 612, automated patient specific medication reordering 613, multiple patient interaction 614, and the provision and organization of ancillary product catalog(s) 615. The multiple patient interaction 614 provides, in one embodiment, an ability for multiple patients to communicate with one another, each patient using his/her patient communication device or personal communication device. Herein, various patients share information with one another concerning the treatment of their disease, as well as specific medication programs in which they participate and are involved. The speed at which patients are educated is greatly increased borrowing upon this integrated communication functionality offered between patients.

For example, the automated bar-code scanning medication logging 621 is provided by the many embodiments shown that provide for coded medication logging. The interactive medication logging 622 provides for the patient 620 to override any of the automated medication logging as well as to enter additional information concerning his/her disease and the treatment or therapy that he/she performs to deal with the diseases. The patient programmable alarm/reminder/message functionality 623 functionality allows the patient 620 to program, independently, alarm functionality that assist the patient, among other things, about reminders of when to self-administer medication. In addition, the patient programs, independently, to receive certain messages that specifically pertain to his/her needs. Analogously, the integrated alarm/reminder/message functionality 624 is tied to the entire system allowing other parties coupled to the system to transmit alarms/reminders/messages to the patient 620 as well as allow the patient 620 to transmit alarms/reminders/messages to the other parties.

For example, the integrated alarm/reminder/message functionality 624 is operable to warn a patient via an alarm that the patient 620 possesses a tainted medication or product. In addition, a party such as a medical doctor uses the integrated alarm/reminder/message functionality 624 to transmit a message specific to the patient 620. The menu driven (custom) data entry/information retrieval functionality 625 provides a manner in which the patient 620 access certain information available within the HemaScan database 610, such as the patient education materials 612 and ancillary product catalog(s) 615. The ancillary product catalog(s) 615 contain information that is needed to perform the administration of the medication to the patient.

Also, the medication management 626 allows the patient 620 the ability to manage and control simply items such as when the patient 620 needs to take his/her medication as well as more advanced functions such as how much he should be taking, borrowing upon the tracking and trending of his/her own medication history. This medication management 626 is performed in close coordination with other parties to the system, such as a medical doctor, in certain embodiments of the invention.

As described above, the medical researchers 671 and the market researchers 673 are inherent beneficiaries of the functionality and inter-communication 600 provided between the many parties and entities of the FIG. 6 as well as each of the other embodiments illustrated in the various Figures above. Though not necessarily integrated parties included within the various embodiments to the invention, their provision of the compiled clinical data (i.e., the functionality of the clinical data compilation 643) will intrinsically benefit all parties specifically included within the invention.

In-view of the above detailed description of the present invention and associated drawings, other modifications and variations will now become apparent to those skilled in the art. It should also be apparent that such other modifications and variations may be effected without departing from the spirit and scope of the present invention.

What is claimed is:

1. A medical management system comprising:
a personal communication device programmed for generating, by a patient, a record of the patient's unforeseen self administration of a medical treatment;
a database;
a network coupling the personal communication device and the database to allow information to pass between the personal communication device and the database;
wherein, the record generated includes a time the medical treatment was administered and additional information about the medical treatment administered;
wherein, the personal communication device sends the record to the database over the network; and
wherein the record is added to the database and is sent directly to a doctor who provides medical services to the patient to alert said doctor about said unforeseen self-administration of a medical treatment.

2. The medical management system of claim 1, wherein a part of the record is interactively generated by input from the patient and a part of the record is automatically generated by the personal communication device.

3. The medical management system of claim 1, wherein the database is processed to initiate an automatic medication reorder.

4. The medical management system of claim 1 further comprising:
one or more communications devices coupled to the network and programmed to allow healthcare providers to access the database and to communicate with patients.

5. The medical management system of claim 1 further comprising:
one or more communications devices coupled to the network and programmed to allow pharmacists to access the database and to communicate with patients.

6. The medical management system of claim 1 further comprising:
one or more communications devices coupled to the network and programmed to allow insurance providers to access the database and to communicate with patients.

7. The medical management system of claim 1, wherein the patient receives warning messages through the personal communication device indicating that the patient possesses tainted medication.

8. The medical management system of claim 1, wherein the database contains patient education material accessible to the patient.

9. The medical management system of claim 1, wherein the database contains a product catalog.

10. The medical management system of claim 1, wherein the database is tailored to the disease hemophilia.

11. The medical management system of claim 1, wherein the database is used to perform tracking and trending of medication administered by the patient.

12. A personal interactive medication logging apparatus comprising:
a processor;
a memory;
a communications interface;
a user interface to receive input from a patient and present information to the patient;
software stored in the memory and executable on the processor for performing functions comprising:
generating a record in response to patient input received from the user interface, wherein the record indicates the patient's unforeseen self administration of a medical treatment, the time the medical treatment was administered, and the patient's symptoms that preceded the medical treatment;
using the communications interface to transmit the record to a central database, outside the personal interactive medication logging apparatus;
sending said record directly to a doctor who provides medical services to the patient to alert said doctor about said unforeseen self-administration of a medical treatment;
using the communications interface to receive messages from the central database comprising warnings; and
using the communications interface to receive messages from medical professionals.

13. The personal interactive medication log of claim 12, further comprising:
a bar code reader; and
wherein the software is further capable of accepting input from the patient via the user interface to activate the barcode reader and use the information retrieved from the barcode reader to add information to the record comprising the identity of a medication being taken by the patient as part of the medical treatment.

14. The personal interactive medication log of claim 12, wherein the software is further capable of automatically generating part of the record, and presenting the record to the patient for review prior to the record's transmission to the database.

15. The personal interactive medication log of claim 12, wherein the software is further capable of retrieving patient education material from the database via the communications interface.

16. A medical treatment logging database comprising:
a processor;
a memory;
a communications interface;
software stored in the memory and executable on the processor for performing functions comprising:
using the communications interface to receive a medical treatment record indicating a patient's unforeseen self administration of a medical treatment, the medical treatment record comprising patient identification information, a type of treatment performed, a time the treatment was performed, and a patient's symptoms that necessitated the treatment;
sending said record to a doctor who provides medical services to the patient to alert said doctor about said unforeseen self-administration of a medical treatments
storing a plurality of received medical treatment records;
examining the stored medical treatment records to initiate a medication reorder for patients whose medication supply is running low.

17. The medical treatment logging database of claim 16, wherein the software is further capable of receiving a record via the communications interface indicating the specific medication possessed by the patient, receiving a tainted medication warning via the communications interface, examining the record indicating the specific medication possessed by the patient, and transmitting a warning to the patient if the patient possesses medication identified in the tainted medication warning.

18. The medical treatment logging database of claim 16, wherein the software is further capable of receiving a request for medication trending, via the communications interface, from a medical professional and processing the plurality of medical treatment records to create a medication trend report.

19. The medical treatment logging database of claim 16, wherein the medical treatment record further comprises an experience that triggered symptoms and a response to treatment.

20. A medical management system comprising:
a communication device programmed for generating, by a patient, a record of the patient's unforeseen self administration of a medical treatment and sending said record directly to a doctor who provides medical services to the patient to alert said doctor about said unforeseen self-administration of a medical treatment;
a database;
a network coupling the communication device and the database to allow information to pass between the communication device and the database;
wherein, the record generated includes a time the treatment was administered and additional information about the treatment;
wherein, the communication device sends the record to the database over the network; and
wherein the record is added to the database.

21. The medical management treatment according to claim 20 wherein the unforeseen self administration is in response to an accident.

22. The medical management treatment according to claim 20 wherein the unforeseen self administration is in response to a medical symptom.

23. The medical management treatment according to claim 20 wherein the unforeseen self administration is in response to a physical reaction.
